(19) United States
(12) Patent Application Publication
(10) Pub. No.: US 2025/0335774 A1
(43) Pub. Date: Oct. 30, 2025

(54) STREAMING DATA SET GENERATION FOR FINE-TUNING MODELS

(71) Applicant: Intuit, Inc., Mountain View, CA (US)

(72) Inventors: Amit KALAMKAR, Fremont, CA (US); Vigith MAURICE, Portland, OR (US)

(21) Appl. No.: 18/651,543

(22) Filed: Apr. 30, 2024

(51) Int. Cl. G06N 3/09; G06F 11/07; G06N 3/0985

(52) U.S. Cl. CPC G06N 3/09; G06F 11/0769; G06F 11/0793; G06N 3/0985

(57) ABSTRACT

Certain aspects of the disclosure pertain to streaming data set generation and machine learning model fine-tuning. Streaming data can be cleansed and enriched in real time before storage in a non-volatile data repository. Cleansing can include context addition, aggregation, and deduplication. Subsequently, cleansed data can be sampled and enriched. Enriching the cleansed data can include employing machine learning and annotating the cleansed data with the output of one or more machine learning models. The enriched data can be saved to a data repository for subsequent retrieval on-demand for fine-tuning. After detecting a trigger, the enriched data can be retrieved from the data repository and utilized to train or fine-tune a target machine-learning model.

### BACKGROUND

### Field

Aspects of the subject disclosure relate to artificial intelligence and, more specifically, fine-tuning machine learning models, including large language models.

### Description of Related Art

Artificial Intelligence (AI) has experienced significant advances in natural language processing (NLP) propelled by the evolution of large language models (LLMs), such as GPT (Generative Pre-trained Transformer) series models. Transformer-based models have gained prominence due to their ability to comprehend and generate human-like text. Generally, transformer-based models undergo extensive pre-training on vast textual data and employ deep learning techniques and neural networks to process and generate text based on input received.

Fine-tuning LLMs tailors such models to specific domains or tasks. Fine-tuning involves retraining an existing language model on specialized data sets to refine the model's performance for specific domains or tasks. Fine-tuning data sets can be acquired from industry-specific repositories or databases, or from crowd-source platforms, where human annotators label or tag data relevant to a specific task.

### SUMMARY

According to one aspect, a method includes receiving a data stream associated with application deployment, wherein the data stream is a continuous sequence of data produced over time, cleansing the data stream by identifying and rectifying one or more error, inconsistency, or missing value, producing a cleansed data stream, enriching the cleansed data stream with one or more machine learning models, producing a transformed data stream, saving the transformed data stream to a repository as transformed data, detecting a trigger event, and initiating fine-tuning of a large language model with the transformed data in response to the trigger event.

According to another aspect, a method includes receiving a data stream associated with application deployment, wherein the data stream is a continuous sequence of operational data produced over time, cleansing the data stream by identifying and rectifying one or more of an error, inconsistency, or missing value, producing a cleansed data stream, enriching the cleansed data stream with one or more machine learning models, producing a transformed data stream, saving the transformed data stream to a repository as transformed data, detecting a trigger event, and initiating fine-tuning of a large language model with the transformed data in response to the trigger event, wherein the large language model is configured to output a natural language summary of an operational event and a potential root cause.

Other aspects provide processing systems configured to perform the aforementioned methods as well as those described herein; non-transitory, computer-readable media comprising instructions that, when executed by a processor of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects of this disclosure.

### DESCRIPTION OF THE DRAWINGS

The appended figures depict certain aspects and are, therefore, not to be considered limiting of the scope of this disclosure.

FIG. 1 is a block diagram of a high-level overview of an example implementation of streaming data set generation and fine-tuning a machine learning model.

FIG. 2 is a block diagram of an example stream processing component.

FIG. 3 is a flow chart diagram of an example enrichment component.

FIG. 4 is a flow chart diagram of an example method of streaming data set generation and fine-tuning.

FIG. 5 is a block diagram of an operating environment within which aspects of the subject disclosure can be performed.

To facilitate understanding, identical reference numerals have been used, where possible, to designate identical elements common to the drawings. It is contemplated that elements and features of one embodiment may be beneficially incorporated in other embodiments without further recitation.

### DETAILED DESCRIPTION

Aspects of the subject disclosure provide apparatuses, methods, processing systems, and computer-readable mediums for streaming data set generation to fine-tune machine learning models, such as LLMs.

Fine-tuning data is influential in enhancing machine-learning models for particular domains or tasks. However, several technical challenges or problems can arise with respect to fine-tuning data that can affect a machine learning model's effectiveness, robustness, or both. For example, obtaining high-quality data for fine-tuning can be challenging, and limited or inadequate data may not capture the full complexity of a target domain or task, thus leading to suboptimal model performance.

Conventionally, batch-processing or crowd-sourcing data is utilized for machine learning model training. Batch processing requires data to be collected and stored over time before the data can be processed and utilized for training. As a result, the data can quickly become outdated or irrelevant and no longer represent current conditions or requirements needed to fine-tune a machine learning model effectively. Crowd-sourcing depends on manual input from human users. However, human annotation or labeling is difficult to scale and can introduce inconsistencies, errors, or biases that adversely affect learning, negatively impacting the model's performance. Furthermore, it can be costly and inefficient in terms of resource utilization to continuously collect data through batching or crowdsourcing, which requires additional data management overhead.

Aspects described herein provide a technical solution to at least the aforementioned technical problems. In particular, aspects described herein relate to a streaming platform that enables data to be collected, cleansed, and enriched in real time as it is received. In one instance, collected and cleansed data can be provided as input to a machine-learning model, and the output can be a tag or label for the input data, thereby enriching the data. In other words, the machine-learning model can provide pseudo labels. These pseudo-labels can be stored and subsequently retrieved and utilized to fine-tune a target machine learning model. Further, positive and negative user feedback regarding the output of a machine learning model provided can be captured, stored, and utilized to fine-tune a machine learning model, trigger fine-tuning, or both. Machine learning models can be fine-tuned by utilizing streaming sources directly to incorporate current information and stay optimized to the latest conditions. Further, machine learning models can be fined-tuned on demand, such as when a negative feedback threshold is satisfied, to address issues promptly rather than waiting for periodically scheduled fine-tuning cycles.

Still further yet, a custom target machine-learning model can be generated based on domain-specific training data, yielding a smaller and equally or more accurate model for the domain than a larger and more general machine learning model. For example, a language model can be generated utilizing proprietary or open-source resources. Subsequently, a large language model such as OpenAI® can enrich streaming data through pseudo labels that can be used to fine-tune the custom target machine-learning model. As a result, the large model's size and generality are leveraged to generate a more compact yet equally or more accurate model that utilizes fewer computing resources and processes requests faster than the large model. In one instance, the domain expertise of the large language model can be transferred to the custom target machine learning model when the output of the large language model is the same as the custom target machine learning model.

For example, consider a scenario in which a custom machine learning model is generated with operational training data associated with a deployed application and generates a text summarization of the operational data. Subsequently, the custom machine learning model can be fine-tuned based on operational data and pseudo labels generated by an industry standard or baseline model, such as OpenAI®. The pseudo labels can correspond to text summarizations of operational data. The custom machine learning model can thus be infused with insight and expertise encapsulated by the text summarizations from the baseline model. In particular, the baseline model can produce more general results and capture aspects unknown to the custom machine learning model. Further, the input operational data can be recent and capture the latest conditions. Combining the strengths of both models can achieve better performance within the domain. Further, the custom machine-learning model can utilize less computing resources than a larger model like the OpenAI® model, improving computing resource efficiency and response time.

### Example Implementation of a Streaming Dataset Generation and Fine-Tuning System

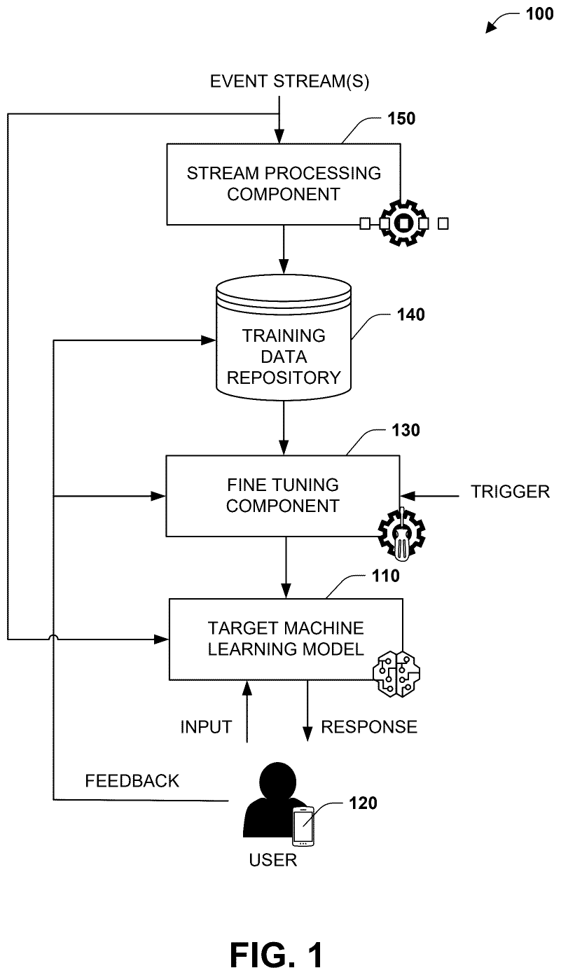

FIG. 1 depicts a high-level overview of an example implementation 100 of streaming data set generation for fine-tuning a machine learning model. The implementation 100 includes a target machine learning model 110, user computing device 120, fine-tuning component 130, training data repository 140, and stream processing component 150.

The target machine learning model 110 can implement a computational algorithm designed to learn patterns and make predictions without being explicitly programmed for a task. The machine learning model 110 can automatically learn and improve from experience. Creating a machine learning model involves training data that includes input data along with corresponding output, often referred to as labels. The machine learning model 110 learns to recognize patterns and relationships in the data, allowing it to make predictions on unseen data. Machine learning models can be involved in various applications, including, but not limited to, image and speech recognition, natural language processing, recommendation systems, and autonomous vehicles.

In accordance with one embodiment, the machine learning model 110 can correspond to a large language model (LLM). An LLM is a natural language processing model trained on vast amounts of text data to enable natural language understanding and generation tasks. The LLM can include transformer-based models, such as generative pre-trained transformer (GPT) series models. The LLM can also be implemented with a proprietary or open-source model. The target machine learning model 110 can be referred to as a target herein to distinguish between other models that aid data generation as described later herein.

A user can utilize a computing device 120 to interact with the target machine learning model 110. The computing device 120 can correspond to a physical entity capable of executing instructions and manipulating data with computational resources. The computational resources can include a central processing unit for carrying out arithmetic and logical operations, volatile memory for temporarily storing data and instructions, non-volatile memory for long-term data retention, and input/output interfaces to interact with users and other devices. The computing device 120 can correspond to a personal computer or a server, among others. In accordance with one embodiment, the machine learning model 110 can reside on a server and be exposed as a network-accessible service. A user can employ a browser executing on the computing device 120 to access the machine learning model 110 in one instance. Of course, the machine learning model 110 can be executed on the computing device 120 employed by a user through an interface in another embodiment.

Per one embodiment, the machine learning model 110 can be an LLM that returns a summarization of operations data and a root cause of an issue associated with a deployed application, where the application is substantially any software application or set of applications including, but not limited to, a financial management application. Consider a situation in which a developer deploys a problematic change to the application that triggers an automatic rollback to return to a state before failure. The machine learning model 110 can be triggered in response to the rollback to aid understanding. The machine learning model 110 receives operational data, such as logs and events (e.g., Kubernetes events), as input from one or more event streams or a data repository storing the operational data from event streams. In response, the machine learning model 110 can generate a summary and predict the root cause. For example, the summary can be “There are 676 information logs indicating that users were successfully logged in and requests were served successfully. The Kubernetes event shows that the container was terminated due to an OOMKilled.” The potential root cause can be “The container was terminated due to an out-of-memory (OOM) error, which may have caused the runtime error in the error log. Too many Redis connections opened may indicate an underlying issue with the connection that caused the runtime error.” This information is highly valuable to developers in expeditiously determining and applying a fix.

The event streams utilized by the target machine learning model 110 to generate a response can also be employed to improve the target machine learning model 110 through fine-tuning component 130. The fine-tuning component 130 is configured to trigger or perform fine-tuning of the machine learning model 110. Fine-tuning refers to adjusting and optimizing a machine learning model, including a pre-trained model, for a specific task or domain. Fine-tuning can thus involve modifying a pre-trained model to suit a target task by adding, removing, or modifying layers and adjusting model parameters, including weights, based on task-specific data. The task-specific data used for fine-tuning can be received from the training data repository 140, which can correspond to a non-volatile computer-readable storage medium. Fine-tuning by the fine-tuning component 130 can be triggered in various ways. In one instance, fine-tuning can be periodic, for example, based on a time after which the machine learning model can be considered “stale.” In another instance, fine-tuning can be initiated in response to receiving an external trigger, such as user feedback regarding model output quality (e.g., thumbs up, thumbs down). For example, fine-tuning can be triggered after negative feedback satisfies a threshold (e.g., number of thumbs down>threshold number). Fine-tuning can also be triggered based on any definable event that may be monitored by a system, such as an event that traverses an event stream.

The stream processing component 150 is configured to receive one or more event streams, automatically process the event streams in real time to generate training data, and save the training data to the training data repository 140 for subsequent use in fine-tuning the target machine learning model 110. An event stream can comprise an ordered sequence of events representing, for example, actions in the software domain. In accordance with one embodiment, the domain can correspond to operational data that describes the health of a computing system and actions performed by the computing system. In the context of operational data, the event actions can correspond to status (e.g., pending, running, successful, failed), state changes, performance metrics (e.g., CPU usage, memory usage), updates, and errors, among other things. For example, an event stream can include application and system log data capturing events, errors, and performance metrics. Further, an event stream can include events about container or pod creation, scheduling, and network activity from an orchestration system. An event stream can also include audit log information comprising details of commands run, configurations changed, and images or versions used.

In addition to data provided by the stream processing component 150, the training data repository 140 can also include user feedback. More specifically, the training data can include user input, model output, and feedback regarding the quality of the output. Based on this data, reinforcement learning with human feedback can be utilized to provide additional training data or further data labeling or annotation that can be exploited to fine-tune a machine learning model. Further, user feedback can trigger fine-tuning to address poor-quality results. For example, fine-tuning can be triggered by negative feedback from users regarding the quality of results. In this manner, just-in-time model fine-tuning can be initiated to promptly address issues rather than waiting for a scheduled tuning session.

### Example Stream Processing Component

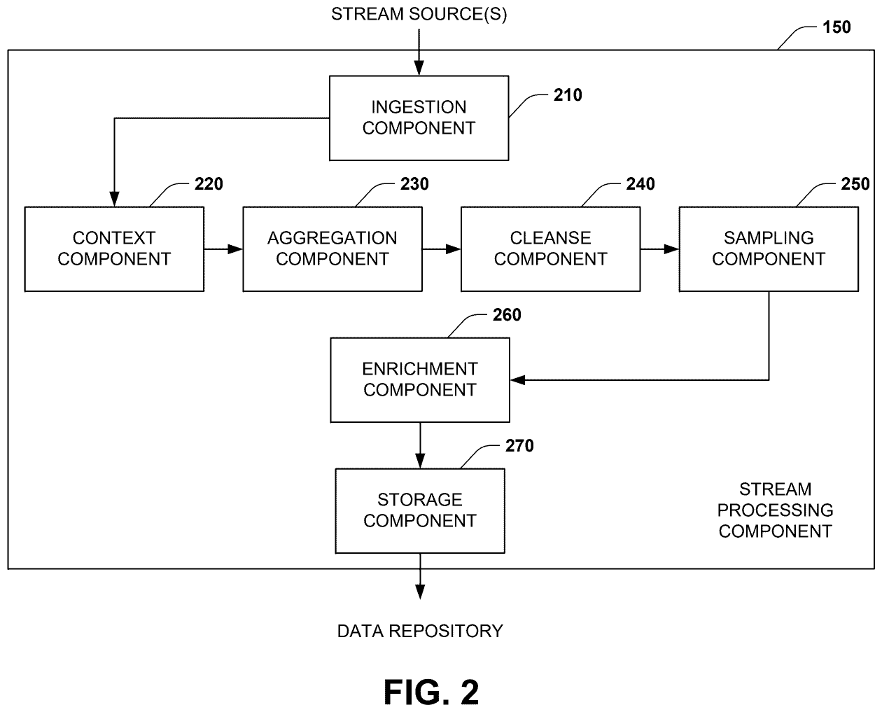

FIG. 2 depicts an example stream processing component 150 in further detail.

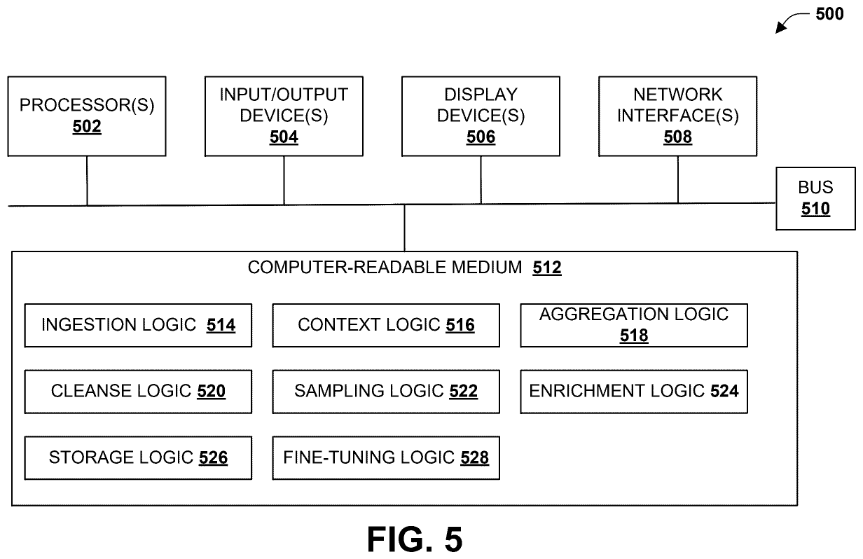

In this example, the stream processing component 150 comprises ingestion component 210, context component 220, aggregation component 230, cleanse component 240, sampling component 250, enrichment component 260, and storage component 270. The ingestion component 210, context component 220, aggregation component 230, cleanse component 240, sampling component 250, enrichment component 260, and storage component 270 can be implemented by at least one processor (e.g., processor 502 of FIG. 5) coupled to at least one memory (e.g., computer-readable medium 512 of FIG. 5) that stores instructions that cause the at least one processor to perform the functionality of each component when executed. Furthermore, all or a portion of the functionality of each component can be performed alone, in conjunction with, or by a machine learning model. Consequently, a computing device can be configured to be a special-purpose device or appliance that implements the functionality of the stream processing component 150.

The ingestion component 210 is configured to receive event streams from various sources and prepare data from the event streams for further processing. In accordance with one embodiment, the ingestion component 210 can include connectors that interface with different stream sources, such as applications, Kubernetes, and metric systems, to pull in raw event data. The ingestion component 210 can also employ buffering mechanisms (e.g., Apache Kafka®) to reliably store and manage high volumes of incoming events in a distributed and scalable manner. Further, the ingestion component 210 can provide initial parsing logic to extract fields like timestamps and identifiers from event payloads and represent them in a uniform format or schema. Additionally, initial data filtering can be performed to remove invalid or incomplete data that does not meet basic formatting, structure requirements, or other requirements. Furthermore, received data can be pushed to an outbound stream to be consumed by downstream processing components, such as the context component 220.

The context component 220 is configured to analyze and annotate incoming event streams with additional contextual metadata. In one instance, metadata can be extracted from event payloads such as timestamps, identifiers, and service tags, among other things. Further, entity resolution may be employed to correlate related events and add context around entities such as users, devices, namespaces, applications, and containers, among other things. The context component 220 may also employ causal inference to determine relationships between dependent events and add relationship information to the metadata. In one particular embodiment, the context component 220 can provide or attribute keys to incoming data (e.g., namespace, application type, application name, and pod name). The contextual metadata facilitates grouping or aggregation by the aggregation component 230.

The aggregation component 230 can receive event streams annotated with contextual metadata by the context component 220 and aggregate event payloads based on the contextual metadata. For example, data can be grouped based on an entity associated with the data (e.g., application, container). In one instance, data can be aggregated after a predetermined time, such as “N” minutes. In other words, data can be grouped based on a given time period in which events occur such that a potentially continuous stream of events can be processed. Additionally, the data can be grouped based on contextual metadata, such as keys attributed to an event.

The cleanse component 240 is configured to detect and address errors, inconsistencies, and inaccuracies within a data set. In other words, the cleanse component 240 performs data cleaning. For example, a common issue includes duplicate data. Duplicate data in streams can arise for assorted reasons, such as network glitches, failures, and retransmissions, among other things. The cleanse component 240 can identify and remove duplicate events from a stream. In one embodiment, a buffer or cache can be employed to store recently processed events and corresponding metadata or attributes. When a new event arrives, the event can be compared to events stored in the buffer to determine if a similar event has been recently processed. If a match is found, the most recent event can be considered a duplicate and filtered out of the stream. Deduplication can improve efficiency of computing resource utilization and improve processing speed. Further removing duplicates can improve data quality and accuracy that would otherwise potentially distort analytical results. The cleanse component 240 is not limited to deduplication and can address other data accuracy issues, including inconsistent formatting and unwanted outliers, among others.

The sampling component 250 is configured to select a subset of events for further processing. The sampling component 250 can be employed to manage the volume of data, reduce computational requirements, and provide insights into event streams without the need to process every event. The sampling component 250 can utilize one of various sampling techniques (e.g., random, systematic) to select events at a determined sampling rate, which determines the proportion of events to be included in the sample.

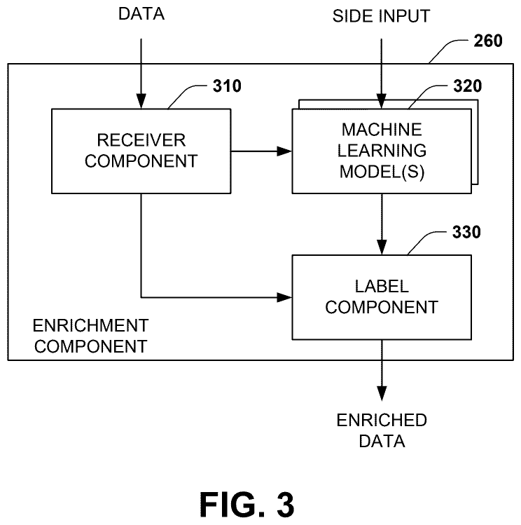

The enrichment component 260 is configured to receive a sample from the sampling component 250 and enrich the data with pseudo labels. The sample of data can be labeled by a machine learning model trained to annotate data with additional metadata and context. In one embodiment, a machine learning model can produce the same type of output as the target machine learning model 110 of FIG. 1 and annotate or otherwise associate the output with the sample as described further with respect to FIG. 3.

The storage component 270 is configured to save enriched data from the enrichment component 260 to a data repository, such as the training data repository 140 of FIG. 1. The storage component 270 persists processed streaming data to a non-volatile computer-readable storage medium. The data repository of processed streaming records can subsequently be exploited as training data to fine-tune a target machine learning model.

Per one embodiment, the storage component 270 can be configured to save data to an append-only data repository (e.g., data can be added, but existing data is immutable) and uni-directional (e.g., moves from left to right). The collected data in the data repository can be employed to fine-tune a target machine learning model based on optimal and sub-optimal responses. Optimal responses can be given more weight, and sub-optimal responses can be removed.

The stream processing component 150 continuously prepares live data for machine learning model fine-tuning. The ingestion component 210 receives initial event streams from one or more systems. These event streams are then processed in real time using stream processor components, such as the context component 220, aggregation component 230, cleanse component 240, sampling component 250, and enrichment component 260, that apply preprocessing and enrichment logic. Consequently, labeled training data is generated dynamically. Fully processed streaming data can be persisted to a data repository that provides the labeled training data for on-demand fine-tuning. By handling the lifecycle from raw event intake through enriched storage, the stream processing component 150 enables target machine learning models to be aligned with evolving conditions by fine-tuning with the latest streaming data inputs.

### Example Enrichment Component

FIG. 3 depicts an example enrichment component 260 in accordance with one embodiment. The example enrichment component 260 includes receiver component 310, machine learning model(s) 320, and label component 330.

The receiver component 310 is configured to receive, retrieve, obtain, or otherwise acquire data. In one instance, the data can correspond to a sample produced by sampling an entire data stream. Further, the data can correspond to operational data associated with a deployed application in an example embodiment. The receiver component 310 can provide the data to the machine learning model(s) 320 and the label component 330.

The machine learning model(s) 320 corresponds to one or more machine learning models trained to output information regarding input data. The machine learning models can be trained for automatic classification and automatic labeling in one instance. A machine learning model can be trained on data and classes to automatically classify text, for example. As per automatic labeling, a machine learning model can be trained on a set of labeled data to enable labeling of new, unlabeled data. In another embodiment, one of the machine learning models(s) 320 can be trained for anomaly detection that identifies data that falls outside normal behavior. Further, a general-purpose LLM can be employed as a machine learning model 320 to produce a variety of outputs, such as output of the same type as a target machine learning model (e.g., summarization, root cause).

The enrichment component 260 is flexible and can include one or more machine learning models 320 depending on a domain and questions that are likely to be asked when the target machine-learning model is a language model. In the ongoing example regarding a target machine learning model that seeks to explain operational data, questions may be asked regarding asset health, asset metrics, the root cause of a problem, container events (e.g., Kubernetes pod restart), and errors in logs, among other things. To address this particular domain and questions, various machine learning models 320 can be useful. In this context, a model fine-tuned for one environment is unlikely to work well for another environment. For example, suppose training or tuning utilizes EKS (Elastic Kubernetes Service) data, a managed Amazon® service, versus self-hosted Kubernetes data. In this situation, the output will vary based on how much information each implementation exposes.

Further, it is to be appreciated that data need not be provided to all machine learning model(s) 320. Rather, the receiver component 310 of the enrichment component 260 can seek to categorize or classify data and forward the data to one or more machine learning model(s) 320 associated with a particular class or category to enable efficient processing.

It is also to be appreciated that a new machine learning model may become available after stream processing has started. More specifically, the target machine learning model 110 can receive streaming data and, when triggered, perform inferencing to produce a result, such as a summarization of operational data before a failure that caused a rollback or root cause of the failure. Halting a streaming process for updates is undesirable. Accordingly, the enrichment component 260 supports the introduction of additional or new machine learning models through what is termed side input. As used herein, side input is a communication mechanism that enables components to receive messages at runtime and potentially change runtime processing. In this instance, a new machine learning model can be identified through the side input and made available for use with all data or data of a particular class without needing to restart or redeploy.

The label component 330 is configured to label or otherwise annotate data with results from the one or more machine learning model(s) 320. For example, the information can be added to metadata.

According to one embodiment, generating a custom target machine-learning model 110 that is rightsized for its application may be desired. Consider, for example, the ongoing example regarding a target machine learning model that summarizes operational data and predicts a likely root cause of any issues. In this instance, a large proprietary language model (e.g., OpenAI®) can be utilized to enrich the data and aid training of a target machine learning model 110 of FIG. 1. Since such a model is designed to respond to requests of a general nature, the language model can be extremely inefficient (e.g., incurring high computational cost) for use for a specific application or domain. Accordingly, a smaller model, such as target machine learning model 110 of FIG. 1, can be developed and fine-tuned based on the results of a much larger model, such as a large proprietary language model 320. Further, the smaller machine learning model can utilize fewer resources and execute faster than a large model while providing equal or better responses to a select domain or task.

The enrichment component 260 exploits machine learning to enrich streaming data in real time, generating labeled training data suitable for continuous model optimization. As event streams are received, machine learning models can automatically annotate the streaming data with pseudo labels that capture insights that improve the quality and usefulness of streaming data for fine-tuning a target machine learning model. Labeled data sets can be created dynamically by programmatically enriching data in real time without additional data labeling expense.

### Example Method of Streaming Data Set Generation and Fine-Tuning

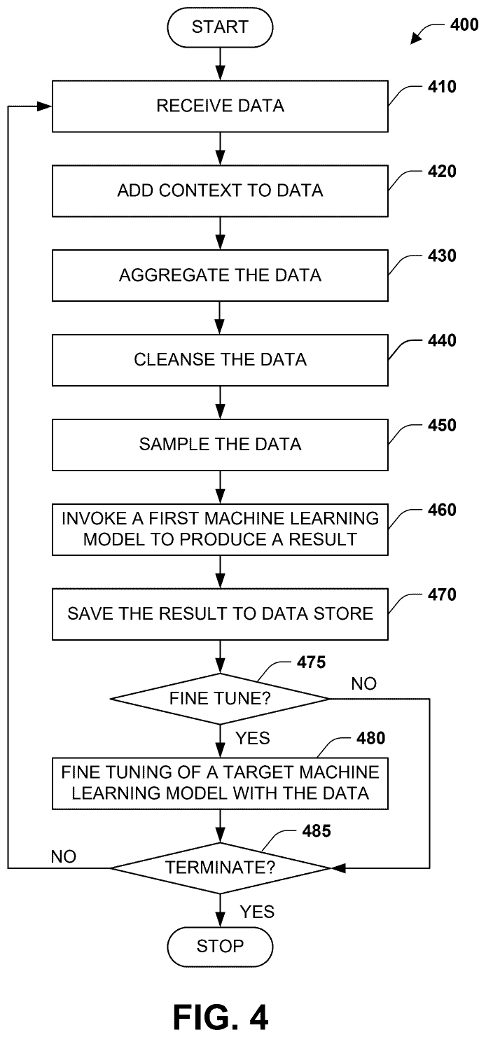

FIG. 4 depicts an example method 400 of data set generation and fine-tuning. In one aspect, method 400 can be implemented by the stream processing component 150 and fine-tuning component 130 of FIG. 1.

Method 400 starts at block 410 with receiving data. Although not limited thereto, the data can correspond to operational data regarding a deployed application. In this scenario, the deployed application or components thereof can provide the data. The provided data can be received, retrieved, or otherwise obtained or acquired from the application in one or more streams. The data can include status, state changes, performance metrics, updates, and errors, among other things, and can be provided in one or more data streams in real time.

Method 400 then proceeds to block 420, with adding context to the data. Contextual information regarding the nature or source of the data in the stream can be determined. For example, the data in one or more streams can correspond to different namespaces, application types, application names, and container names, among other things. This contextual information can be added to metadata associated with the data to at least facilitate aggregation. Further, context can be added in real time as the data is ingested.

Method 400 continues next to block 430, with aggregating the data. In accordance with one aspect, aggregating data corresponds to grouping data based on the context data associated with the data. For example, data that concerns the same source, such as an application name or type, can be grouped. Further, aggregation can correspond to groupings based on time. For instance, after every “N” minutes, data can be aggregated for further processing. Data aggregation reduces the data volume by consolidating data, which improves downstream processing and storage. Further, attribute-based grouping facilitated analysis per dimension, such as container or application, for comparative purposes. Aggregation can also present data in a more structured format suitable for machine learning tasks (e.g., prediction and classification) that require aggregated features. Data can be aggregated in real time as the data is ingested after context addition.

Method 400 continues to block 440, with applying one or more cleansing operations to the data. Cleansing operations contribute to data quality, consistency, and reliability. For example, cleansing operations can include deduplication, filtering, formatting, and filling in missing data, among others. Deduplication can involve removing duplicate data to ensure data integrity and accuracy. Filtering can involve removing irrelevant or unwanted data. Formatting converts data to a consistent format to aid subsequent analysis. Missing data can be handled by identifying and managing missing values to maintain data completeness. Cleansing the data can be performed in real time as data from a stream is ingested after aggregation.

Method 400 proceeds next to block 450, with sampling the data. Sampling involves selecting a representative subset of incoming data for analysis rather than processing all data points to address challenges of processing large volumes of real time data. Sampling offers several benefits, including reduced computational requirements, decreased storage needs, and faster processing speeds.

Method 400 proceeds to block 460, with invoking a machine learning model to process the data sample and output pseudo labels. The machine learning model can be trained to output the pseudo labels on input sample data. For example, the machine learning model can automatically classify text into one or more predefined categories that correspond to labels. As another example, the machine learning model can correspond to an anomaly detection model that identifies unusual patterns or outliers in data and identifies them as such. Furthermore, a large language model can be employed, asked to explain an input, and tag data with an explanation. Additionally, a machine learning model can be trained to identify the root cause of an issue or problem. One or more machine learning models can be executed to enrich the data with pseudo labels. In one embodiment, a plurality of machine learning models can be made available, and a subset of the models are utilized based on relevancy to a particular domain. Furthermore, one or more machine learning models can be added through the use of side input in an always-on streaming process. For example, if a new data source or domain begins streaming data, an additional machine learning model associated with that source or domain can be added and configured for use.

Labeling data can also be performed in real time as the data is ingested. As a result, labeling is performed expeditiously and without additional subsequent labeling costs. Further, exploiting streaming data sources directly, rather than relying on batch processing or crowdsourcing data, enables continuous model optimization on current data.

Method 400 continues to block 470, with saving the data enrichment results to a non-volatile data repository. The enrichment results can be saved together with the data enriched as labels. In one instance, metadata of the data can be annotated with the labels or results.

Method 400 proceeds to block 475, where a determination is made as to whether fine-tuning should be performed. The determination can be based on one or more trigger conditions. In one instance, fine-tuning can be triggered after a predetermined time (e.g., two weeks, a month) associated with the model becoming stale. In another instance, fine-tuning can be triggered by negative feedback from users regarding the quality of results. In this manner, just-in-time model fine-tuning can be initiated to promptly address issues rather than waiting for a scheduled tuning session. For example, a threshold amount of negative feedback can be the trigger condition, such that satisfaction of the threshold initiates fine-tuning. If fine-tuning is to be performed (“YES”), the method advances to block 480. If fine-tuning is not to be performed (“NO”), the method proceeds to block 485.

At block 480, fine-tuning of a target machine learning model is initiated with the saved data. It is to be appreciated that well other actions of method 400 can be performed in real time. Once triggered, fine-tuning of the target model can be performed offline. Subsequently, the method continues at block 485.

At block 485, a determination is made as to whether the method 400 is to terminate. The method 400 can run continuously, gathering and processing data in real time. However, there may be a situation in which the method 400 terminates. For example, if an upgrade is made to the method 400. If the method 400 is not to terminate (“NO”), the method 400 continues at block 410, where more data is received. If the method 400 is to terminate (“YES”), the method 400 stops.

The method 400 provides continuous training or fine-tuning of machine learning models using live data sources. Data streams can be processed as they are generated rather than being batch-processed or crowdsourced after the fact. As the event streams are received, the method 400 automatically preprocesses (e.g., context, aggregate, cleanse, sample) and labels the data in real time. Consequently, labeled training examples are produced with minimal or no additional annotation costs. The processed data is then stored and can be dynamically accessed for just-in-time model updates. New data sources or domains can trigger reconfiguration of processing logic to maintain optimized performance. User feedback is also incorporated in the long term to refine model quality. Overall, an efficient end-to-end solution is provided that handles full data preparation, storage, and fine-tuning that can support various use cases. The continuous training approach also aims to keep target machine learning models closely aligned with the latest real-world conditions.

Note that FIG. 4 is just one example of a method, and other methods including fewer, additional, or alternative steps are possible consistent with this disclosure.

### Example Processing System for Streaming Data Set Generation and Fine-tuning

FIG. 5 depicts an example processing system 500 configured to perform various aspects described herein, including, for example, methods as described above with respect to FIGS. 3 and FIG. 4.

Processing system 500 is generally an example of an electronic device configured to execute computer-executable instructions, such as those derived from compiled or interpreted computer code, including without limitation personal computers, tablet computers, servers, smart phones, smart devices, wearable devices, augmented or virtual reality devices, and others.

In the depicted example, processing system 500 includes one or more processors 502, one or more input/output devices 504, one or more display devices 506, and one or more network interfaces 508 through which processing system 500 is connected to one or more networks (e.g., a local network, an intranet, the Internet, or any other group of processing systems communicatively connected to each other), and computer-readable medium 512.

In the depicted example, the aforementioned components are coupled by a bus 510, which may generally be configured for data or power exchange amongst the components. Bus 510 may be representative of multiple buses, while only one is depicted for simplicity.

Processor(s) 502 are generally configured to retrieve and execute instructions stored in one or more memories, including local memories like the computer-readable medium 512, as well as remote memories and data stores. Similarly, processor(s) 502 are configured to retrieve and store application data residing in local memories like the computer-readable medium 512, as well as remote memories and data stores. More generally, bus 510 is configured to transmit programming instructions and application data among the processor(s) 502, display device(s) 506, network interface(s) 508, and computer-readable medium 512. In certain embodiments, processor(s) 502 are included to be representative of one or more central processing units (CPUs), graphics processing units (GPUs), tensor processing units (TPUs), accelerators, and other processing devices.

Input/output device(s) 504 may include any device, mechanism, system, interactive display, or various other hardware components for communicating information between processing system 500 and a user of processing system 500. For example, input/output device(s) 504 may include input hardware, such as a keyboard, touch screen, button, microphone, or other device for receiving inputs from the user. Input/output device(s) 504 may further include display hardware, such as, for example, a monitor, a video card, or other device for sending or presenting visual data to the user. In certain embodiments, input/output device(s) 504 is or includes a graphical user interface.

Display device(s) 506 may generally include any device configured to display data, information, graphics, user interface elements, and the like to a user. For example, display device(s) 506 may include internal and external displays, such as an internal display of a tablet computer or an external display for a server computer or a projector. Display device(s) 506 may further include displays for devices, such as augmented, virtual, or extended reality devices.

Network interface(s) 508 provide processing system 500 access to external networks and processing systems. Network interface(s) 508 can generally be any device capable of transmitting or receiving data through a wired or wireless network connection. Accordingly, network interface(s) 508 can include a transceiver for sending or receiving wired or wireless communication. For example, Network interface(s) 508 may include an antenna, a modem, a LAN port, a Wi-Fi card, a WiMAX card, cellular communications hardware, near-field communication (NFC) hardware, satellite communication hardware, or any wired or wireless hardware for communicating with other networks or devices/systems. In certain embodiments, network interface(s) 508 includes hardware configured to operate in accordance with the Bluetooth® wireless communication protocol.

Computer-readable medium 512 may be a volatile memory, such as a random access memory (RAM), or a non-volatile memory, such as non-volatile random access memory, phase change random access memory, or the like. In this example, computer-readable medium 512 includes ingestion logic 514, context logic 516, aggregation logic 518, cleanse logic 520, sampling logic 522, enrichment logic 524, storage logic 526, and fine-tuning logic 528.

In certain embodiments, ingestion logic 514 receives data streams from various sources and provides the data streams to downstream processing components. The ingestion component 210 FIG. 2 can perform the ingestion logic 514.

In certain embodiments, the context logic 516 analyzes and annotates data from a stream with contextual metadata, such as a corresponding entity associated with data. The context logic 516 can be performed by the context component 220 of FIG. 2.

In certain embodiments, aggregation logic 518 aggregates data from streams based on contextual metadata. The aggregation component 230 of FIG. 2 can perform the aggregation logic 518.

In certain embodiments, cleanse logic 520 cleans data by identifying and correcting incomplete, duplicated, incorrect, and irrelevant data. The cleanse component 240 of FIG. 2 can perform the cleanse logic 520.

Sampling logic 522 selects a representative subset from a data stream in certain embodiments. The sampling component 250 of FIG. 2 can perform the sampling logic 522.

In certain embodiments, enrichment logic 524 generates enriched data, for instance, by utilizing one or more machine learning models. The enrichment component 260 of FIG. 2 can perform the enrichment logic 524.

In certain embodiments, storage logic 526 saves processed streaming data to a non-volatile data repository. The storage component 270 of FIG. 2 can perform the storage logic 526.

Fine-tuning logic 528 retrains a machine learning model based on a streaming data set in certain embodiments. The fine-tuning component 130 of FIG. 1 can perform the fine-tuning logic 528.

Note that FIG. 5 is just one example of a processing system consistent with aspects described herein, and other processing systems having additional, alternative, or fewer components are possible consistent with this disclosure.

### Example Clauses

Implementation examples are described in the following numbered clauses:

Clause 1: A method comprising: receiving a data stream associated with application deployment, wherein the data stream is a continuous sequence of data produced over time; cleansing the data stream by identifying and rectifying one or more of an error, inconsistency, or missing value, producing a cleansed data stream, the cleansed data stream with one or more machine learning models, producing a transformed data stream, saving the transformed data stream to a repository as transformed data, detecting a trigger event, and initiating fine-tuning of a target machine learning model with the transformed data in response to the trigger event.

Clause 2: The method of Clause 1, wherein enriching the cleansed data stream with one or more machine learning models comprises adding one or more pseudo labels to the cleansed data stream.

Clause 3: The method of Clauses 1-2, wherein cleansing and enriching the data stream is performed in real time as the data stream is received.

Clause 4: The method of Clauses 1-3, further comprising: receiving a supplemental machine learning model through a side input, and adding the supplemental machine learning model to the one or more machine learning models.

Clause 5: The method of Clauses 1-4, further comprising: assigning data in the data stream to a class, and forwarding the data in the data stream to at least one of the one or more machine learning models associated with the class.

Clause 6: The method of Clauses 1-5, wherein detecting the trigger event further comprises: receiving user feedback associated with the output of the target machine learning model, and determining that negative user feedback satisfies a threshold.

Clause 7: The method of Clauses 1-6, further comprising: receiving user feedback associated with the output of the target machine learning model, and initiating the fine-tuning with the output and the user feedback as a label.

Clause 8: The method of Clauses 1-7 wherein the target machine learning model is a large language model configured to output a natural language summary of an operational event and a potential root cause.

Clause 9: The method of Clauses 1-8, wherein the operational event is a rollback of the application deployment.

Clause 10: A processing system, comprising: a memory comprising computer-executable instructions and a processor configured to execute the computer-executable instructions and cause the processing system to perform a method in accordance with any one of Clauses 1-9.

Clause 11: A processing system, comprising means for performing a method in accordance with any one of Clauses 1-9.

Clause 12: A non-transitory computer-readable medium storing program code for causing a processing system to perform the steps of any one of Clauses 1-9.

Clause 13: A computer program product embodied on a computer-readable storage medium comprising code for performing a method in accordance with any one of Clauses 1-9.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various elements, steps, or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, method steps, and flow components described in the present disclosure may be implemented or performed with a general-purpose processor, a special-purpose processor (e.g., an artificial intelligence processor), combinations of general-purpose and special-purpose processors, and other programmable logic devices, or any combination thereof. A general-purpose processor may be a microprocessor, a commercially available processor, a controller, a microcontroller, or a state machine. A processor may also be implemented as a combination of computing devices.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, “real time” refers to processing with minimal and acceptable delay. The term emphasizes immediacy while recognizing that some level of latency exists in any system. The term practically targets a time frame imperceptible to a user or within the requirements of a particular application without requiring instantaneous or zero latency responses.

Throughout this disclosure, the discussion focused on fine-tuning a machine learning model to mitigate or resolve performance drift or adding or adjusting prompts. In accordance with one embodiment, a machine-learning model can be trained or retrained from scratch using the same data used to fine-tune a currently existing model. Training a new model requires more time than fine-tuning a model, which is why fine-tuning is often preferred. However, this disclosure also applies to training a new model.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory), and the like. Also, “determining” may include resolving, selecting, choosing, establishing, and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as one or more buses.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to general and special-purpose processors.

The following claims are not intended to be limited to the aspects shown herein, but are to be accorded the full scope consistent with the language of the claims. Reference to an element in the singular is not intended to mean only one element unless specifically so stated, but rather “one or more” elements. The subsequent use of a definite article (e.g., “the” or “said”) with respect to an element (e.g., “the processor”) is not intended to limit the claim to an interpretation requiring only a single element (e.g., “only one processor”) unless otherwise specifically stated. For example, reference to an element (e.g., “a processor,” “a controller,” “a memory,” “the processor,” “the controller,” “the memory,”), unless otherwise specifically stated, should be understood to refer to one or more elements (e.g., “one or more processors,” “one or more controllers,” “one or more memories,”).

The terms “set” and “group” in the claims are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system, a processing system, or an apparatus) to perform functions, one element may be configured to cause the other element to perform all functions, or more than one element may collectively be configured to cause the other element to perform the functions.

Unless specifically stated otherwise, the term “some” refers to one or more.

All structural and functional equivalents to the elements of the various aspects described throughout this disclosure that are known or later become known to those of ordinary skill in the art are intended to be encompassed by the claims. Moreover, nothing disclosed herein is intended to be dedicated to the public, regardless of whether such disclosure is explicitly recited in the claims.

What is claimed is:

1. A method, comprising:
receiving a data stream associated with application deployment, wherein the data stream is a continuous sequence of data produced over time;
cleansing the data stream by identifying and rectifying one or more of an error, inconsistency, or missing value, producing a cleansed data stream;
enriching the cleansed data stream with one or more machine learning models, producing a transformed data stream;
saving the transformed data stream to a repository as transformed data;
detecting a trigger event; and
initiating fine-tuning of a target machine learning model with the transformed data in response to the trigger event.

2. The method of claim 1, wherein enriching the cleansed data stream with one or more machine learning models comprises adding one or more pseudo labels to the cleansed data stream.

3. The method of claim 1, wherein cleansing and enriching the data stream is performed in real time as the data stream is received.

4. The method of claim 1, further comprising:
receiving a supplemental machine learning model through a side input; and
adding the supplemental machine learning model to the one or more machine learning models.

5. The method of claim 1, further comprising:
assigning data in the data stream to a class; and
forwarding the data in the data stream to at least one of the one or more machine learning models associated with the class.

6. The method of claim 1, wherein detecting the trigger event further comprises:
receiving user feedback associated with an output of a target machine learning model; and
determining that negative user feedback satisfies a threshold.

7. The method of claim 1, further comprising:
receiving user feedback associated with an output of the target machine learning model; and
initiating the fine-tuning with the output and the user feedback as a label.

8. The method of claim 1, wherein the target machine learning model is a large language model configured to output a natural language summary of an operational event and a potential root cause.

9. The method of claim 8, wherein the operational event is a rollback of the application deployment.

10. A system, comprising:
at least one processor; and
at least one memory coupled to the at least one processor that stores instructions, that when executed by the at least one processor, cause the system to:
receive a data stream associated with application deployment, wherein the data stream is a continuous sequence of data produced over time;
cleanse the data stream by identifying and rectifying one or more of an error, inconsistency, or missing value, producing a cleansed data stream;
enrich the cleansed data stream with one or more machine learning models, producing a transformed data stream;
save the transformed data stream to a repository as transformed data;
detect a trigger event; and
initiate fine-tuning of a target machine learning model with the transformed data in response to the trigger event.

11. The system of claim 10, wherein enrich the cleansed data stream with one or more machine learning models comprises addition of one or more pseudo labels to the cleansed data stream.

12. The method of claim 1, wherein cleanse the data stream and enrich the cleansed data stream is performed in real time as the data stream is received.

13. The system of claim 10, wherein the instructions further cause the system to:
receive a supplemental machine learning model through a side input; and
add the supplemental machine learning model to the one or more machine learning models.

14. The system of claim 10, wherein the instructions further cause the system to:
assign data in the data stream to a class; and
forward the data in the data stream to at least one of the one or more machine learning models associated with the class.

15. The system of claim 10, wherein detect the trigger event further comprises:
receive user feedback associated with an output of the target machine learning model; and
determine that negative user feedback satisfies a threshold.

16. The system of claim 10, wherein the instructions further cause the system to:
receive user feedback associated with an output of the target machine learning model; and
initiate the fine-tuning with the output and the user feedback as a label.

17. The system of claim 10, wherein the target machine learning model is a large language model that outputs a natural language summary of an operational event and a potential root cause.

18. The system of claim 17, wherein the operational event is a rollback of the application deployment.

19. A method, comprising:
receiving a data stream associated with application deployment, wherein the data stream is a continuous sequence of operational data produced over time;
cleansing the data stream by identifying and rectifying one or more of an error, inconsistency, or missing value, producing a cleansed data stream in real time;
enriching the cleansed data stream with one or more machine learning models, producing a transformed data stream in real time;
saving the transformed data stream to a repository as transformed data;
detecting a trigger event; and
initiating fine-tuning of a large language model with the transformed data in response to the trigger event, wherein the large language model is configured to output a natural language summary of an operational event and a potential root cause.

20. The method of claim 19, wherein detecting the trigger event further comprises:
receiving user feedback associated with the output of the large language model; and
determining that negative user feedback satisfies a threshold.
